(19) United States
(12) Patent Application Publication
(10) Pub. No.: US 2025/0014136 A1
(43) Pub. Date: Jan. 9, 2025

(54) COMMUNICATION NETWORK NODE, METHOD, COMMUNICATION NETWORK, TERMINAL DEVICE

(71) Applicant: Sony Group Corporation, Tokyo (JP)

(72) Inventor: Hideji WAKABAYASHI, Basingstoke (GB)

(73) Assignee: Sony Group Corporation, Tokyo (JP)

(21) Appl. No.: 18/712,260

(22) PCT Filed: Dec. 14, 2022
(86) PCT No.: PCT/EP2022/085999

§ 371 Date: May 22, 2024

(30) Foreign Application Priority Data
Dec. 17, 2021 (EP) 21215734.1

(51) Int. Cl. G06Q 50/40; G06Q 10/047

(52) U.S. Cl. CPC G06Q 50/40; G06Q 10/047

(57) ABSTRACT

The present disclosure generally pertains to a communication network node including circuitry configured to: acquire user input which is indicative of at least one service factor indicating user experience; and predict a user experience based on a deterministic model including the at least one service factor.

### TECHNICAL FIELD

The present disclosure generally pertains to a communication network node, a method, a communication network, and a terminal device for providing a distributed ledger in the field of mobility as a service.

### TECHNICAL BACKGROUND

Generally, it is known to distribute a ledger over multiple nodes such as entities, e.g. electronic devices, servers or the like, which record digital transactions. Distributed ledgers can be based on the known blockchain technology, on which, for example, the known cryptocurrency bitcoin is based, but also the well-known Ethereum project, etc. Generally, a distributed ledger may also be implemented on other technologies than the blockchain technology and examples of distributed ledger projects which are not based on blockchain are BigchainDB and IOTA or the like. For instance, IOTA is a crypto currency which uses linked lists.

Moreover, mobility as a service (MaaS) is known, where a user or passenger uses mobility as a service without owning, for example, a car or the like. Mobility as a service may combine public (e.g. train, bus, etc.) and private (e.g. car sharing, bicycle sharing, etc.) transportation services from associated operators or providers.

Known MaaS solutions typically involve a central and unified gateway through which a trip or journey is planned and booked, wherein a user may pay with a single account.

Although there exist techniques for providing a distributed ledger and mobility as a service, it is generally desirable to provide a communication network node, a user equipment, a communication network and a method for providing mobility as a service.

### SUMMARY

According to a first aspect, the disclosure provides a communication network node comprising circuitry configured to:
acquire user input which is indicative of at least one service factor indicating user experience; and
predict a future user experience based on a deterministic model including the at least one service factor.

According to a second aspect, the disclosure provides a method carried out in a communication network node, the method comprising:
acquiring user input which is indicative of at least one service factor indicating user experience; and
predicting a user experience based on a deterministic model including the at least one service factor.

According to a third aspect, the disclosure provides a communication network comprising a communication network node including circuitry configured to:
acquire user input which is indicative of at least one service factor indicating user experience; and
predict a user experience based on a deterministic model including the at least one service factor.

According to a fourth aspect, the disclosure provides a terminal device being configured to communicate with a communication network node in a communication network, the terminal device being further configured to:
provide a user input which is indicative of at least one service factor indicating user experience; and
obtain a user experience which is predicted based on a deterministic model including the at least one service factor.

Further aspects are set forth in the dependent claims, the following description and the drawings.

### BRIEF DESCRIPTION OF THE DRAWINGS

Embodiments are explained byway of example with respect to the accompanying drawings, in which:

FIG. 1 depicts a system overview including a communication network node according to the present disclosure;

FIG. 2 depicts a sequence diagram of a method according to the present disclosure on how the entities of FIG. 1 can interact;

FIG. 3 depicts an embodiment of a regression pattern (as a linear curve) according to the present disclosure;

FIG. 4 depicts further embodiments of regression patterns according to the present disclosure;

FIG. 5 depicts a flow chart depicting a method for costumer experience estimation based on regression;

FIG. 6 depicts a sequence diagram of a method according to the present disclosure;

FIG. 7 depicts an embodiment of a neural network implementing a machine learning algorithm according to the present disclosure;

FIG. 8 depicts a method according to the present disclosure in a block diagram which is carried out based on a learned machine learning algorithm;

FIG. 9 depicts a further embodiment of a method according to the present disclosure in a block diagram;

FIG. 10 depicts a further embodiment of a method according to the present disclosure as carried out in a terminal device;

FIG. 11 depicts a blockchain and its general data structure;

FIG. 12 illustrates an input and output of a hash function;

FIG. 13 exemplarily illustrates the process PBFT;

FIG. 14 depicts an embodiment of a general purpose computer; and

FIG. 15 depicts an embodiment of a user equipment and of an electronic network node.

### DETAILED DESCRIPTION OF EMBODIMENTS

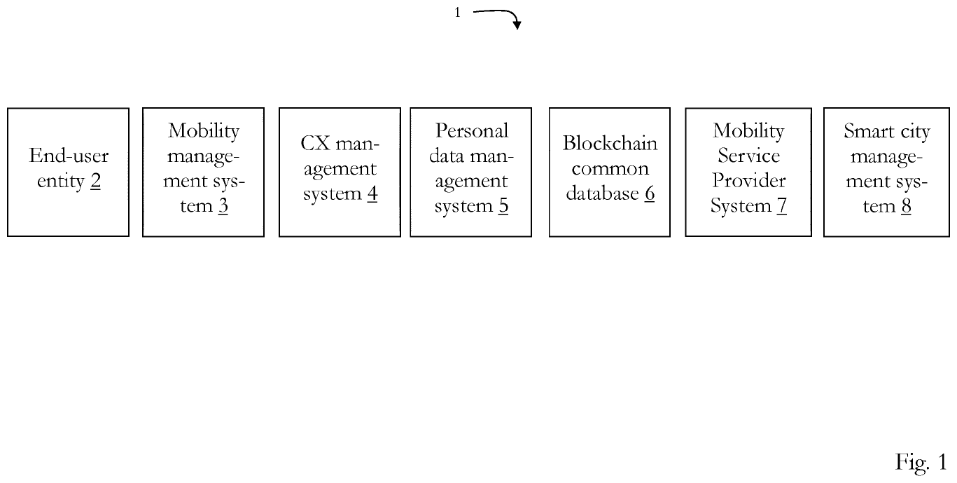

Before a detailed description of the embodiments starting with FIG. 1 is given, general explanations are made.

In the following, some terminology definitions are given, which may be applied in some embodiments (without limiting the present disclosure to the definitions given in the following. The definitions are only examples which are provided for enhancing the understanding of the present disclosure and which are only given, since the technology fields of MaaS and distributed ledgers are highly dynamical and definitions may change in the future.).

The term “distributed ledger” may be known from Wikipedia, which defines: “distributed ledger (also called a shared ledger, or distributed ledger technology, DLT) is a consensus of replicated, shared, and synchronized digital data geographically spread across multiple sites, countries, or institutions. There is no central administrator or centralized data storage.”

The technology of a distributed ledger and of a special example of it, namely of a blockchain, will also be discussed further below. More generally, the term distributed ledger is used as a type of database shared digitally recorded data with multiple nodes of a network. It may be comprised of peer to peer network. The digitally recorded data may include a kind of information to prove its consistency from the previously recorded data on the same database.

Distributed ledgers can be public and can be accessible by anyone, but, in principle, they can also be non-public and only users having a permission may have access to them, wherein a group of entities, nodes, persons, operators, providers or the like which have the permission may also referred to as “consortium”, as will also be explained further below. It is also possible to differentiate the access permission to data on a ledger from each layered users.

Distributed ledgers can use mechanisms, which are known, for example, from the blockchain technology as used for bitcoin. Such mechanisms include a discovery method, a consensus mechanism, a mechanism to keep data consistency and so on. The consensus mechanism ensures that all nodes or more than a certain number of nodes, generally electronic devices, having a copy of the distributed ledger reach consensus on the content of the distributed ledger. There are many consensus mechanisms including the so-called proof-of-work mechanism, which is some kind of crypto-puzzle and which ensures that, for example, older blocks of a blockchain cannot be changed (easily). For instance, proof-of-work is used for the mining process of the bitcoin blockchain.

In a distributed ledger or blockchain, a confirmation process to make a consensus about data renewal on a blockchain in attending nodes, called a mining process, may achieve irreversibility of the sequence of transactions recorded on the blockchain by including previous recorded data in the confirming data. Such mining process implements a distributed timestamp server for a new block of transactions. In bitcoin (and, thus, in some embodiments) the mining process is based on the SHA-256 hash function. Nodes of the blockchain that participate in the mining process search for a hash output with predefined properties while the input of the hash function depends on the current blocks of the blockchain and the new block of transactions to be added to the blockchain.

Proof-of-work computations based on hash functions may not be useful in themselves except that they are required to implement the irreversibility of the distributed ledger.

Moreover, generally, it is known to use a blockchain for storing a variety of data. For instance, images, videos, measurements, and text files can be recorded on the blockchain in the form of a transaction.

The term “Mobility as a service (MaaS)”, is also exemplarily known from Wikipedia, which defines: “Mobility-as-a-Service (MaaS) describes a shift away from personally-owned modes of transportation and towards mobility solutions that are consumed as a service. This is enabled by combining transportation services from public and private transportation providers through a unified gateway that creates and manages the trip, which users can pay for with a single account. Users can pay per trip or a monthly fee for a limited distance. The key concept behind MaaS is to offer travelers mobility solutions based on their travel needs.”

The term “mobility service provider” may be a catch-all name of any type of service provider MaaS. In some embodiments, it is typically a transport organization, such as railway companies, bus/coach, tram and taxi, car sharing, ride sharing, bike sharing and so on. Some of the mobility service providers may not provide the actual transport means, but may provide only a booking/arrangement, comparable to a travel agency or online booking site or the like. To a mobility service provider (or MaaS provider), it may also be referred to as “transport operator”, in some embodiments.

The term “passenger” may refer to a person who has a service contract with a home mobility service provider or which is a costumer of a home mobility service provider (defined below).

The term “home mobility service provider” may refer to a mobility service provider being located or operating in a fixed area (e.g. country, city), and may be a mobility service provider with which a passenger may have a contract, e.g. for a pass, tickets, subscriptions, and the like. The passenger may be multiple service providers, as well, in some embodiments.

A “mobility service provider” (also referred to as “MaaS service provider”) may be a superordinate term for the terms “home mobility service provider” and “roaming mobility service provider” (which are defined below), and may refer to an operator, a society, a company, and the like, which offers a mobility service in a specific mobility service area (e.g. a town, a country, a region, air route, water route).

User experience may refer to a person's perceptions and responses that result from the use or anticipated use of a product, system, or service. For example, when using a ticket machine of a railway, the usability on how easy a target train can be found and how easy the ticket can be purchased to the destination.

Customer experience may refer to a person's perceptions, not only result from the use or anticipated use of a service, but also based on indirect factors.

For example, when taking a train, quality may be defined based on an availability of a seat, punctuality, but also based on indirect factors such as a cleanness of the train, of a waiting room, accessibility of a railway station (e.g. elevator to/from platform), or the like.

In some embodiments, customer experience and user experience may be used as synonyms.

It has been recognized that it may be desirable that the mobility service may orient based on the wishes of the user/costumer, i.e., to offer a mobility service from a passenger point of view, which may integrate multiple transport services.

Several levels of MaaS integration may be considered, in accordance with a white paper from “MaaS alliance”, which can be obtained as follows: https://maas-alliance.eu/wp-content/uploads/sites/7/2018/11/MaaS-brochure-ENG.pdf

Level 0=no integration. This basic level refers to the situation in which separate services are provided for different means of transport.

Level 1=integration of information. At this level, travel information is provided through (multi-modal) travel planners, which may or may not include information on routes and costs. The added value level 1 holds for users is that it facilitates the choice regarding the time of day, the route, or the mode of transport to be used.

Level 2=integration of finding, booking, and payment. At this level, MaaS facilitates the finding, booking, and payment of individual trips. The added value of level 2 is that users can find, book, and pay for their trip at a single service point (e.g., through an app with a pre-registered credit card).

Level 3=integration of transport services into passes and bundles. At this level, MaaS does not just cover individual travel movements; the service also meets the full daily mobility needs of individuals and families by offering different means of transport through bundles and/or passes. The added value of level 3 is that MaaS now offers users an alternative covering all their daily mobility requirements. Thus, it also constitutes an alternative for individual car ownership (according to Sochor et al., 2017).

Level 4=integration of societal goals. At this level, MaaS extends beyond liaising between the demand for and supply of mobility. Supply and demand are now combined with goals such as reducing the use of cars or promoting livability in the cities.

In order to realize the different levels, it has been recognized that it may be desirable to predict or estimate current or future user experience instead of relying on past future experience. When realizing level 4, it has been recognized that different factors may have to be considered which are not necessarily quantifiable or which are in different domains, such as road congestion, overcrowded train, air pollution, noise from transport, or the like.

Hence, it has been recognized that it is desirable to provide a supply and demand management system and method to maximize the social benefit.

According to the present disclosure, it may be provided for improved customer/user experience.

However, it has been recognized that customer experience may be subjective. Hence, it may be desired to set objective measures in order to predict a customer/user experience (e.g., if a customer does not like to participate in a survey).

Moreover, there may be factors which the customer/user does not realize to be of importance to him/her.

Furthermore, if the satisfaction is known after the travel, the customer/user may already be unhappy and thus, it may be desirable to know in advance how the customer/user will experience the travel.

It has been recognized that a route ranking may be carried out based on future (predicted) user experience. Only the future user experience may be the basis for the ranking or other factors may be taken into account, such as at least one of a probability, a distance, a time sequence, an amount of required time, a required fee, a number of travel methods, or the like.

Moreover, it has been recognized that it may be desirable to provide a customer-centric service rather than a transport operator-oriented service, i.e., that not the customer has to adjust for the service, but vice versa.

According to the present disclosure, assets may be provided in accordance with, for example, governmental requirements on MaaS, as may be given according to the following web page from the UK government (without limiting the present disclosure in that regard): https://assets.publishing.service.gov.uk/government/uploads/system/uploads/attachment_data/file/766759/Mobilityasaservice.pdf

The following citation is taken from above paper and the points discussed therein may be overcome according to the present disclosure:

“Traditionally, mobility systems have comprised fixed assets (such as rail tracks or road ways, power and control equipment, storage and maintenance depots, and passenger stations and stops) and mobile units (vehicles) which, when combined together with a set of (often extremely strict) rules for their operation, enabled the movement of goods and people (Ortuzar and Willumsen, 2011). This means that:
users have very little direct ability to influence the type/level of public transport service they receive, certainly in the immediate term, unless they can access a lift, or else pay significantly more to opt for a taxi or minicab
operators are legally required to provide the services they are registered to, whether or not anybody actually uses them on a particular day
services are initially introduced based on limited amounts of historic customer needs/preference data, which is then aggregated and averaged across the day/week/year and the route network, using ticketing data where available”

Therefore, some embodiments pertain to a communication network node including circuitry configured to: acquire user input which is indicative of at least one service factor indicating user experience; and predict a user experience based on a deterministic model including the at least one service factor.

The communication network node may include a computer, a server, a terminal device, or the like. Moreover, multiple of such components (e.g. several servers, which may also be coupled to terminal devices, and the like) may be envisaged. Generally, functions may be provided by software in a cloud service, such that this communication network node is not a physical node in some embodiments. The communication network node may be virtualized and, e.g., provided by a software-based solution. For example, the software-based functions could be deployed in the commercial cloud service (public cloud), in on-premise cloud (private cloud), in Multi-access Edge Computing (MEC) in the telecom network operator, and the like.

The user input may be a direct or an indirect input and may be of one or of many users. For example, the input may be based on a (digital) survey, on historical data, of a travel frequency, or the like.

FIG. 1 depicts a system overview 1 including a network node according to the present disclosure.

The system 1 includes an end-user entity 2, a mobility management system 3, a CX (costumer experience) management system 4, a personal data management system 5, a blockchain common database 6, a mobility service provider system 7, and a smart city management system 8, which will be shortly described in the following:

### End-User Entity 2

End user entity may be in charge of user interfaces function for passengers. It may refer to a logical function, however, a physical device may include various devices, such as a smart phone, an Internet website, user terminal in railway stations/airports, or the like.

The passenger may request the travel and select the offered routes/transport in the end-user entity 2.

The end-user entity 2 may be used as or may store or provide a ticket of transport system, e.g., with QR code, NFC, wifi, 5G communication, or the like.

### Mobility Management System 3

The mobility management system 3 may be in charge of providing a MaaS service to a passenger.

The mobility management system 3 may negotiate with a transport service provider for the best route.

Moreover, the mobility management system 3 may provide a management of a journey, such as start of journey, arrival at destination, cancel of journey, or the like.

### Customer Experience (CX) Management System 4

The CX management system 4 may provide and store customer experiences for a passenger. Moreover, it may survey/monitor customer experience and feedback to other systems (e.g. the mobility management system 3, and predict/estimate customer experience (e.g., AI based, regression based, or the like) and provide to another system (e.g. route selection in the mobility management system 3)

### Personal Data Management System 5

The personal data management system 5 may manage customer subscription and/or tickets (e.g., type of subscription like monthly basis, allowance per month, or the like), personal data (e.g. passport info, driving license, payment method like credit card info, or the like), preferences of travel (e.g. use first class, avoid air travel, or the like).

For example, for business travel, the personal data management system 5 may include a company's travel policy/travel allowance. For example, the system may offer the hotel/air travel in line with company's travel policy.

### Blockchain Common Database 6

A blockchain may serve as a common database between MaaS service providers and transport operators. It may record travel transactions, such as ride on the train, get off train, or the like. The travel record may be shared among transport operators and data may be used for a transport cost calculation. The blockchain 6 may be distributed database MaaS providers, transport operators, or the like. If MaaS adopts a conventional database (e.g. centralized relational database), it may be used instead of a blockchain based database.

### Mobility Service Provider (Transport Operator) System 7

The mobility service provider system 7 may offer transports/routes in respond to the request from a passenger via the mobility management system 3 and may arrange the transport/book the seat for the passenger.

### Smart City Management System 8

The smart city management system 8 may monitor traffic (status of road congestion/estimated journey) in a city and thus may yield information about time/road traffic control, dynamic road pricing, or the like.

The entities of FIG. 1 may be assigned to different owners. For example, the end-user entity may be owned by the customer/user/passenger. A MaaS service provide may own the mobility management system 3, the CX management system 4, and the personal data management system 5. A transport operator may own the mobility service provider system 7. The blockchain common database 6 may be operated or owned by a consortium, or the like. The smart city management system 8 may be owned by a government, for example.

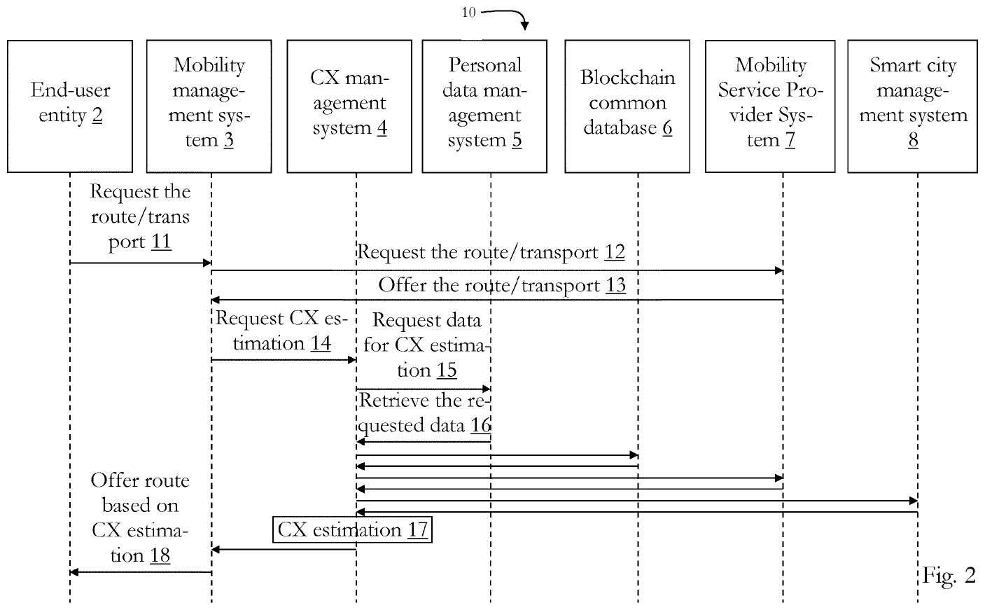

FIG. 2 depicts an sequence diagram 10 of a method according to the present disclosure on how the different entities of FIG. 1 may interact with each other.

At 11, the user puts a target destination/arrival time. The end-user entity 2 requests the travel to mobility management system 3.

The mobility management system receives the travel request and transmits, at 12, the request to one or more transport operators of the mobility service provider system 7.

The mobility service provider system 7 offers, at 13, the route (or multiple routes) with time/price to the mobility management system 3.

At 14, the mobility management system 3 request customer experience (CX) estimation to the CX management system 4 for respective routes/transports.

At 15, the CX management system 4 requests information/data for estimation of CX to the personal data management system 5, the blockchain 6, the mobility service provider system 7, and the smart city management system 8.

At 16, information, preferences, statistics, historical data and so on which may be considered for estimating the user experience, as will be discussed below, are retrieved from the entities 5 to 8 to the CX management system 4, such that, at 17, the customer experience is estimated/predicted by the CX management system 4, which sends the result to the mobility management system 3.

The mobility management system 3 shows the options of the route/transport to the passenger based on the estimated CX (for example, route ranking based on CX).

In some embodiments, the at least one service factor includes a quantitative factor.

The quantitative factor may be measured.

In some embodiments, the quantitative factor includes at least one of on-board time, waiting-time, waiting-time for transition, a number of changes, a number of persons at a station, a number of persons inside a train, transport costs, punctuality, unexpected delay, and a number of complaints to a transport service.

In some embodiments, the at least one service factor includes a qualitative factor.

The qualitative factor may be derived and quantified, such that it may be input for the CX estimation, as will be discussed further below.

In some embodiments, the qualitative factor includes at least one of comfort options (e.g., possibility to relax, comfortability), purpose of travel (e.g. leisure, business), additional travel services (e.g., Wifi, refreshment), accessibility (e.g., how to get to the rail station, lift, stairs), easiness of luggage handling, familiarity of the user with the transport service, familiarity of the user with the destination (if the passenger goes to a destination or an intermediate stop for the first time, additional time might have to be planned), risk of traffic accident, security, public safety, public health (e.g. disease prevention), and user health (e.g. possibility to ride bike, walk, run, lose weight).

In some embodiments, the circuitry is further configured to: acquire a measurement of the at least one service factor.

Some factors may directly measured. For example, a delay time of a transport vehicle may be measured by a timer in the MaaS system, a railway control system, a smartphone with location services, or the like. Some factors may be indirectly measured. For example, a status of a crowded railway station may be monitored by a (CCTV) camera.

Hence, in some embodiments, the measurement is carried out by at least one of a railway control system, a smartphone, and a camera.

In some embodiments, the factors are determined based on a user input.

For example, the customer preferences may be registered in the MaaS system in advance. For example, a customer may input undesirable/desirable transport (e.g. air travel due to fear of flying) customer inputs the allowable distance of walking (e.g. ten minutes walk). Based on the input, the MaaS system may offer a route without exceeding the limit.

In another example, a one-time input is obtained as a special request for a journey. For example, a customer input purpose of travel (leisure, business, or the like) may be taken into account by the MaaS system for selecting the route/transport.

In some embodiments, the circuitry is further configured to: carry out a deterministic calculation of the at least one service factor.

Some factors may be directly determined based on the route or type of transport. For example, on-board time on train or bus, waiting time for transition in railway station, the number of changes. These factors may be deterministically calculated based on the timetable.

In terms of customer experiences, other factors may be taken into account in addition to the above-mentioned factors. For example, some passengers may select the preferable transport based on a shortest journey time. Some passengers may select the preferable transport based on the smaller number of changes. These preferences may be stored in the personal data management system 5.

In some embodiments, the deterministic calculation includes calculating at least one of an on-board time, a waiting time, and a number of changes.

In some embodiments, the deterministic calculation is indicative of at least one of a preferable transport and a journey time.

In some embodiments, the deterministic calculation includes regression.

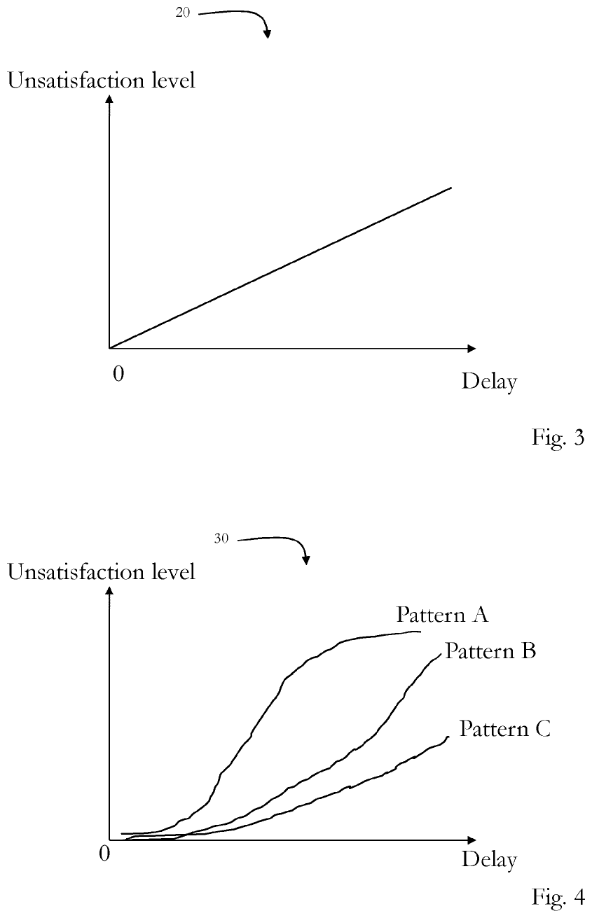

FIGS. 3 and 4 depict exemplary regression patterns 20 and 30 based on which the deterministic calculation may be carried out.

The regression pattern 20 of FIG. 3 is a linear curve in which an unsatisfaction level is linearly dependent on a delay time.

FIG. 4 depicts three exemplary regression patterns A, B, and C which may be used based on the circumstances and which may be stored in the CX management system 4.

The patterns may be derived from a look-up table, based on empiric data, based on an artificial intelligence, or the like.

The patterns may depend on a purpose of travel or another factor.

Pattern A represents a pattern for short distance and business (e.g., commuter). Pattern B represents a long distance and business trip. Pattern C represents long distance and leisure trip.

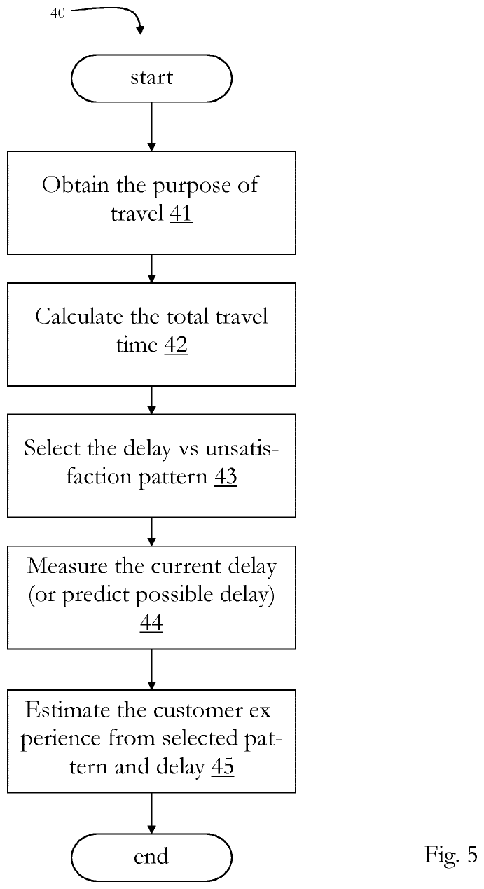

FIG. 5 depicts a flow chart depicting a method 40 for CX estimation based on regression.

At 41, a purpose of travel is obtained.

At 42, a total travel time is calculated.

At 43, a pattern is selected.

At 44, a current delay is determined (measured) and/or a possible delay is predicted.

At 45, the customer experience is estimated based on the selected pattern and based on the delay.

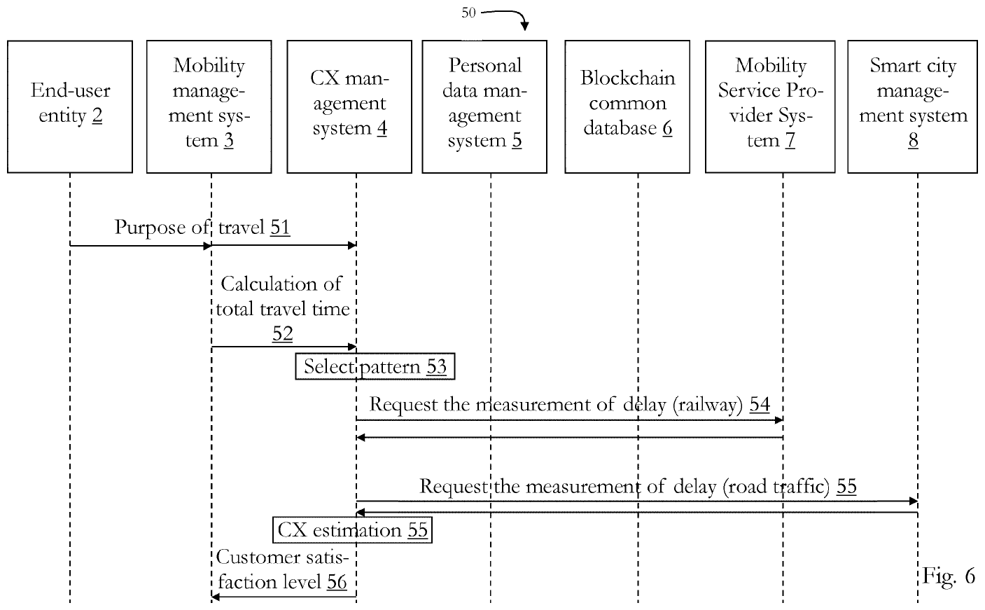

FIG. 6 depicts a sequence diagram 50 which is applied in the present disclosure, in some embodiments.

At 51, the passenger inputs the purpose of travel which is transferred to the CX management system via the mobility management system 3.

At 52, the mobility management system 3 calculates the total travel time and transfers it to CX management system.

At 53, the CX management system 4 selects the delay vs. satisfaction pattern.

At 54, the CX management system 4 requests the current delay from the mobility service provider system 7 (or predict the possible delay).

At 55, CX estimation is carried out by the CX management system 4, which is transmitted to the mobility management system 3, at 56.

Hence, in some embodiments, the regression includes multiple pattern regression, as discussed herein.

In some embodiments, the circuitry is further configured to: acquire a travel history of the user.

One of the indirect methods, as discussed above, may refer to the use of historical information in the previous travels such as a frequently visited place and/or frequently used transport. For example, if a customer often selected a route/transport between home and the frequently visited place, the system may store the record of travel and prioritize to offer the same route/transport next time if it is available.

In some embodiments, the circuitry is further configured to: prioritize a travel route based on the travel history.

In some embodiments, some of the factors may be disregarded, i.e., input factors may be reduced, such that a calculation of the experience may be simplified due to dimensionality reduction. For example, linear discriminant analysis may be carried out, without limiting the present disclosure in that regard.

Dimensionality reduction may be applied in the case of a machine learning algorithm (as discussed below) or in any other algorithm (deterministic model) which is applied for predicting the user experience.

In some embodiments, the deterministic model includes a machine learning algorithm, such that in such embodiments, there may be no need to determine the relevant factors in advance and such that a relation between input parameters and an output value may be found.

This embodiment shows the prediction of customer experiences by machine learning. In some embodiments, pre-emptive action may be carried out with prediction. For example, AI technologies may understand the customer's needs without asking and offer the service.

In some embodiments, the machine learning algorithm is based on at least one input variable.

In some embodiments, the at least one input variable includes at least one of a measurement result, a calculation, historical data, configured values, and qualitative factors.

In some embodiments, the machine learning algorithm includes: quantifying a qualitative factor of the at least one service factor based on the user input.

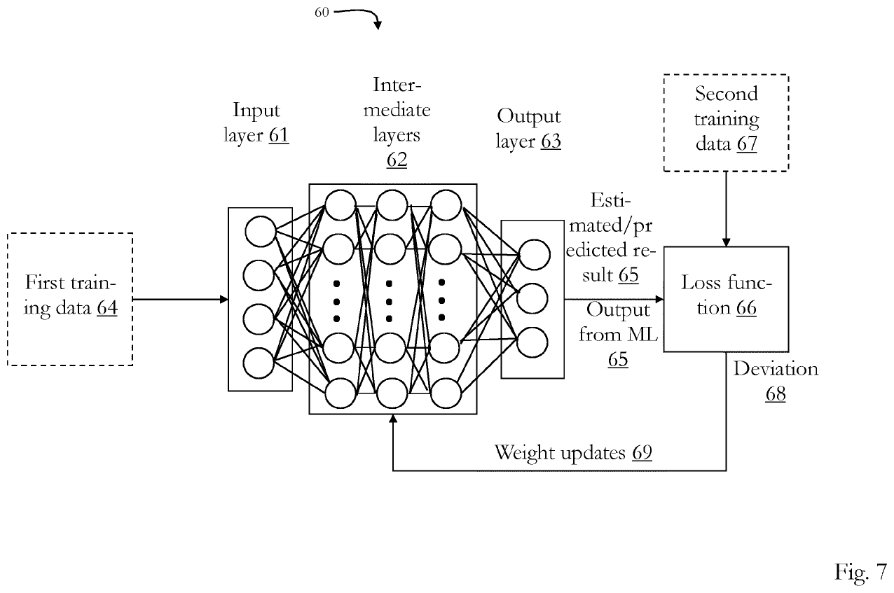

FIG. 7 depicts an embodiment of a neural network 60 implementing a machine learning algorithm according to the present disclosure.

The neural network 60 includes an input layer 61, several intermediate layers 62, and an output layer 63, wherein different nodes (e.g., neurons) of the different layers 61 to 63 are interconnected lay-er-wise with each other, as depicted in FIG. 7.

First training data 64 are input into the input layer 61. The first training data include at least one of, but are not limited to one or more measurements, one or more calculations (e.g., deterministic, prediction, estimation), one or more configured values, historical data (e.g. traffic status in history), or any qualitative (e.g. passenger preferences) or quantitative factor.

Input shape of the machine learning algorithm may depend on input variables. If qualitative factors are input into the machine learning algorithm, they may be converted (as will be discussed further below).

The present disclosure is not limited to any number of intermediate layers 62 and the number may depend on the circumstance. For example, if more intermediate layers 62 are used, a feature may be captured better, but the training time may increase with the number of layers.

The output layer 63 outputs estimated/predicted results 65 from the machine learning (ML) into a loss function 66.

An output shape may also depend on the required output. For example, binary or any other numerical values may be output for estimating the customer satisfaction level (e.g. integer from 0 to 255, wherein 0 means unhappy, 255 means very happy).

Moreover, second training data 67 are input into the loss function 66. The second training data include costumer/user satisfaction data which serve as ground truth for training the machine learning algorithm to recognize the customer satisfaction based on measurement, calculation, and so on, as discussed herein.

The loss function may be used for the weight updating of the machine learning algorithm during a training phase. The loss function may calculate the deviation between the estimated value and an actual value. If the deviation is above a predetermined threshold, the machine learning model may further be trained.

The loss function may have at least two inputs, model output 65 and an actual value (i.e., the second training data), which may include historical data from a customer survey, for example.

The calculation carried out by the loss function may include determining a Mean Squared Error (MSE) for prediction/estimation.

However, MSE may be susceptible to an outliner. For example, if a passenger is unhappy for different reason than considered in the model, the customer satisfaction level may still be low. However, the trained model may be overfitting to the outliner. In that case, the outliner may be filtered (removed) before input or another loss function may be used which is less susceptible to outliner like Mean Absolute Error (MAE).

Based on a deviation 68 of the output from the machine learning algorithm 65 to the second training data 67, which is determined based on the loss function 66, weight updates 69 are carried out in the machine learning algorithm/neural network 60 based on a back propagation algorithm.

The CX management system 4 may identify the context of the customer (e.g. reason of travel). For example, when a customer may request the journey from home to a sightseeing spot at a weekend or holidays, the CX management system 4 may predict leisure as travel purpose. On the other hand, when a customer may request the journey from the home to a branch office, the system may predict business as a travel purpose.

Such a prediction may be taken into account in the machine learning algorithm.

However, if there are too many input factors and data, machine learning may be harder to implement (see also “curse of dimensionality”).

In order to avoid overfitting of the machine learning algorithm to an irrelevant input, feature selection or feature extraction techniques are implemented, in some embodiments. For example, feature selection may refer to removing certain input factors, for example, if two input factors are (highly) correlated with each other, only one of them is selected (since the other one may easily be derived). Feature extraction may thus combine more than one inputs to one input. For example, Principal Component Analysis (PCA) may be utilized.

The present disclosure is not limited to any type of neural network or machine learning algorithm. For example, a CNN (convolutional neural network), an RNN (recurrent neural network), or the like may be used.

The input data for the machine learning algorithm may be pre-processed, for example qualitative factors may be transformed into quantities (i.e., the qualitative factor may be quantified, as discussed above), such that a numerical input may be available for the machine learning algorithm.

For example, a label may be encoded, which is discussed in the following with the exemplary embodiment of a luggage size.

The passenger may input the luggage size when requesting the travel. Air travel may require informing airline companies of luggage size and amount of luggage in advance, but the present disclosure is not limited to air travel since luggage size may be considered useful in any transport environment.

The simplest case may be one bit (yes or no), i.e., whether passenger has luggage or not.

Another case is an amount of luggage (e.g., two suitcases) and/or luggage weight (e.g. thirty kilograms)

In another embodiment, options for luggage size may be given.

Numerical values may be assigned to corresponded to each label, e.g., based on a conversion table (Table 1).

In this embodiment, a large number is assigned to a large luggage size, such that the machine learning model can properly handle the intention of label.

### Table 1 the Example of Numerical Conversion (Luggage Size)

| Label | numerical values |
|---|---|
| No luggage | 0 |
| Handbag only | 1 |
| Standard size luggage | 2 |
| Oversize luggage | 3 |

Another embodiment of pre-processing may refer to one-hot encoding, which may be used additionally or alternatively to labelling.

The machine learning model may consider numerical values. However, multiple options in qualitative factors may not have the same meaning in every case.

For example, a number may correspond to a preference of the user, such as, rail=0, air=1, sea=2, car=3. The machine learning model may “misunderstand” the relation between the numbers.

For example, the large number may have a more important or higher priority.

Therefore, in this case, a neutral way of conversion is provided, based on Table 2, as shown below.

In this case, each label has just one value, others are zero. However, there are four separate variables after conversion.

### Table 2 the Example of Numerical Conversion (Preferable Transport)

| Label | numerical | numerical | numerical | numerical |
|---|---|---|---|---|
| (preferable | values | values | values | values |
| transport) | (rail) | (air) | (sea) | (car) |
| rail | 1 | 0 | 0 | 0 |
| air | 0 | 1 | 0 | 0 |
| sea | 0 | 0 | 1 | 0 |
| car | 0 | 0 | 0 | 1 |

In some embodiments, the machine learning algorithm includes, in the case of more than one input variable: reducing the at least one input variable based on a dimension reduction technique, as discussed herein.

In some embodiments, the communication network node is for providing a distributed ledger, as discussed herein.

In some embodiments, the distributed ledger is based on a blockchain, as discussed herein.

Some embodiments pertain to a method carried out in a communication network node, the method including: acquiring user input which is indicative of at least one service factor indicating user experience; and predicting a user experience based on a deterministic model including the at least one service factor, as discussed herein.

The method may be carried out by circuitry, as discussed herein.

In some embodiments, the at least one service factor includes a quantitative factor, as discussed herein. In some embodiments, the quantitative factor includes at least one of on-board time, waiting-time, waiting-time for transition, a number of changes, a number of persons at a station, a number of persons inside a train, transport costs, punctuality, unexpected delay, and a number of complaints to a transport service, as discussed herein. In some embodiments, the at least one service factor includes a qualitative factor, as discussed herein. In some embodiments, the qualitative factor includes at least one of comfort options, purpose of travel, additional travel services, accessibility, easiness of luggage handling, familiarity of the user with the transport service, familiarity of the user with the destination, risk of traffic accident, security, public safety, public health, and user health, as discussed herein. In some embodiments, the method further includes: acquiring a measurement of the at least one service factor, as discussed herein. In some embodiments, the measurement is carried out by at least one of a railway control system, a smartphone, a and camera, as discussed herein. In some embodiments, the method further includes: carrying out a deterministic calculation of the at least one service factor, as discussed herein. In some embodiments, the deterministic calculation includes calculating at least one of an on-board time, a waiting time, and a number of changes, as discussed herein. In some embodiments, the deterministic calculation is indicative of at least one of a preferable transport and a journey time, as discussed herein. In some embodiments, the deterministic calculation includes regression, as discussed herein. In some embodiments, the regression includes multiple pattern regression, as discussed herein. In some embodiments, the method further includes: acquiring a travel history of the user, as discussed herein. In some embodiments, the method further includes: prioritizing a travel route based on the travel history, as discussed herein. In some embodiments, the deterministic model includes a machine learning algorithm, as discussed herein. In some embodiments, the machine learning algorithm is based on at least one input variable, as discussed herein. In some embodiments, the at least one input variable includes at least one of a measurement result, a calculation, historical data, and qualitative factors, as discussed herein. In some embodiments, the machine learning algorithm includes: quantifying a qualitative factor of the at least one service factor based on the user input. In some embodiments, the machine learning algorithm includes, in the case of more than one input variable: reducing the at least one input variable based on a dimension reduction technique, as discussed herein. In some embodiments, the communication network node is for providing a distributed ledger, as discussed herein. In some embodiments, the distributed ledger is based on a blockchain, as discussed herein.

The methods as described herein are also implemented in some embodiments as a computer program causing a computer and/or a processor to perform the method, when being carried out on the computer and/or processor. In some embodiments, also a non-transitory computer-readable recording medium is provided that stores therein a computer program product, which, when executed by a processor, such as the processor described above, causes the methods described herein to be performed.

Some embodiments pertain to a communication network including a communication network node including circuitry configured to: acquire user input which is indicative of at least one service factor indicating user experience; and predict a user experience based on a deterministic model including the at least one service factor, as discussed herein.

In embodiments in which the communication network node is for providing a distributed ledger, the communication network may be considered to be for providing a distributed ledger accordingly.

Some embodiments pertain to a terminal device being configured to communicate with a communication network node in a communication network, the terminal device being further configured to: provide a user input which is indicative of at least one service factor indicating user experience; and obtain a user experience which is predicted based on a deterministic model including the at least one service factor, as discussed herein.

The terminal device may be embodied by an end-user entity, as discussed above

FIG. 8 depicts a method 60 according to the present disclosure in a block diagram which is carried out based on a learned machine learning algorithm, as discussed above.

At 71, user input is acquired (i.e. input into the neural network 60) which is indicative of at least one service factor indicating user experience.

At 72, a future user experience is predicted, and output, based on the machine learning algorithm which is the deterministic model in this case.

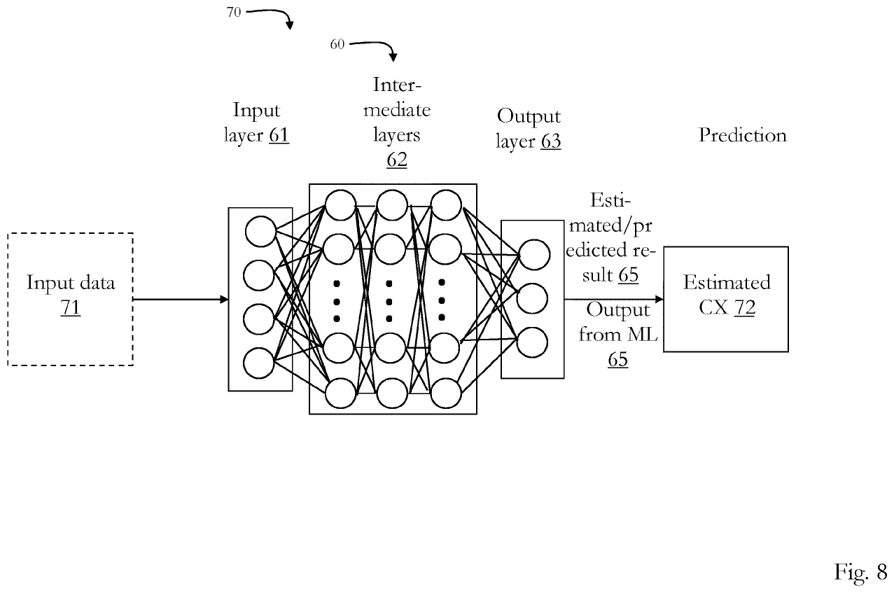

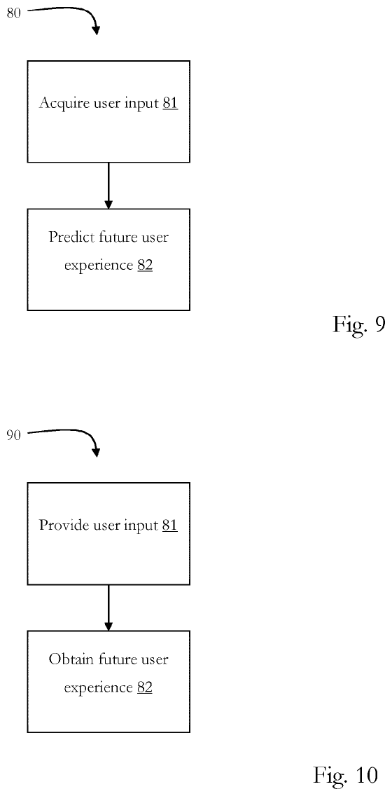

FIG. 9 depicts a further method 80 according to the present disclosure.

At 81, a user input is acquired, as discussed herein.

At 82, a future user experience is predicted based on a regression algorithm, as discussed herein.

FIG. 10 depicts a further method 90 according to the present disclosure which may be carried out in a terminal device or an end-user entity, as discussed herein.

At 91, a user input is provided, as discussed herein.

At 82, a future user experience is obtained, as discussed herein.

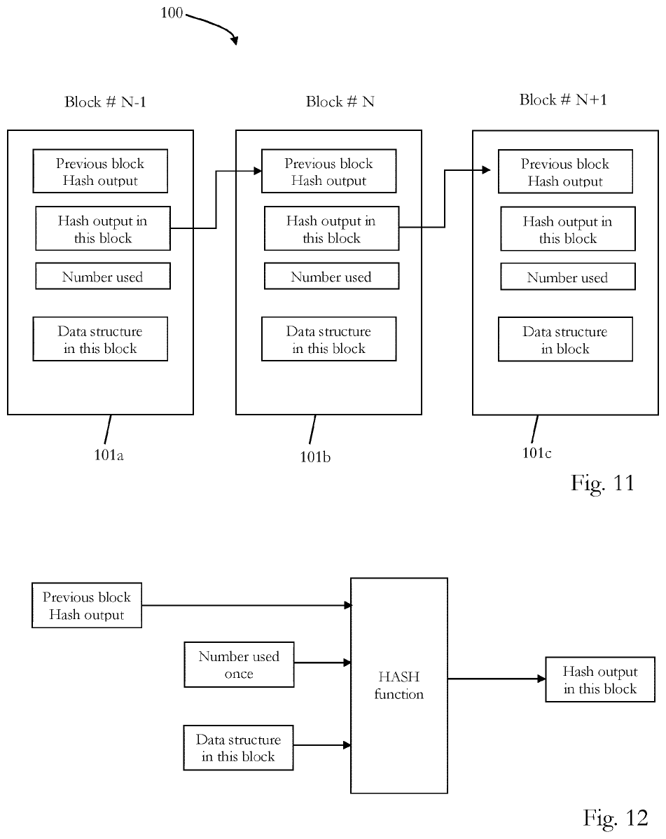

In the following a blockchain and its general data structure will be explained under reference of FIG. 11. In this embodiment of a blockchain, features are a network/topology, a consensus algorithm a Hash function, participant authentication, a scalability/block structures and performance.

FIG. 11 illustrates a general structure of a blockchain 100. The blockchain 100 includes a chain of multiple data blocks 101a, 101b and 101c, wherein the block 101b is a current block (Block #N), the block 101a is a previous block (Block #N−1) and the block 101c is a future or successor block (Block #N+1). Each block includes a hash function result of a previous block, a main data structure, an input value for hash function and hash function result of the current block, wherein the hash function result of current block (101b) is always used as input to the next block (101c).

Moreover, each block includes a “Number used once”, which is a one-shot random number for a secure blockchain processing, and which can prevent replay attack. For instance, if an attacker copies the previous transmitted data and reuses the copied data again for spoofing, the receiver is able to detect the spoofing communication because the next data must be used with a different “number used once”. This random number is sometimes referred to as “nonce” in cryptocurrency.

Additionally, the time stamp may be inserted in each of the blocks 101a, 101b and 101c. The blockchain 100 is an example of a distributed ledger, which may be used, for example, for providing MaaS in some embodiments.

FIG. 12 illustrates the input and output of a hash function, which is used, for example, for the blockchain 100 of FIG. 11.

Generally, a hash function is any function that can be used to map input data to output data with a specific algorithm. The size of input data can be large and various, contrarily the output of data could be compact and can have a fixed size. A known (and famous) algorithm which is used for hashing in some blockchain embodiments is the Secure Hash Algorithm (SHA) designed by the United States National Security Agency (e.g. SHA-2, SHA-256).

The input for the hash function are a previous hash output, the number used once and the main body of data in the current block (e.g. block 101b in FIG. 11). The output of the hash function is a unique value response to the input values. If someone tries to tamper the main body of data, the output of hash function cannot be consistent.

Embodiments of a distributed ledger (blockchain) in this disclosure may implement a consensus protocol or algorithm. For instance, in some embodiments, the Byzantine Fault Tolerance (BFT) is used for the consensus protocol, which is resilient to spoofing of database and fault of hardware.

A well-known consensus algorithm, which is implemented in some embodiment, is the so-called Practical Byzantine Fault Tolerance (PBFT).

In some embodiments, a permission blockchain is used and the relatively small number of permissioned blockchain nodes are in charge of consensus (validation of block).

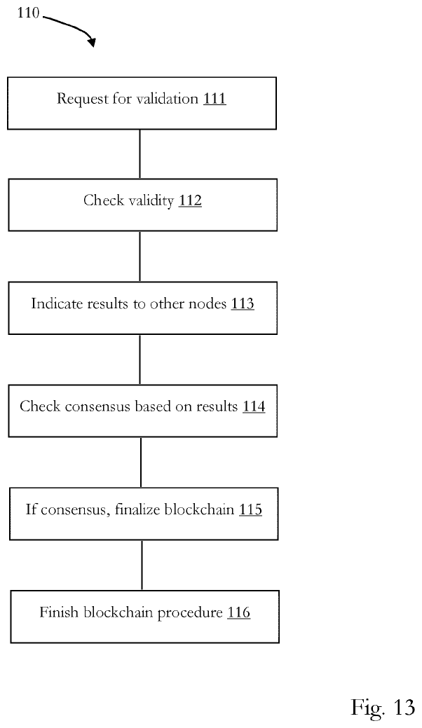

FIG. 13 exemplary illustrates a process 110 of PBFT.

A leader node (it also called non-validating peer) requests at 111 other nodes to validate the blockchain. At 112, each requested node (validate peer) checks the validity of the blockchain with a hash function and indicates its result to other nodes at 113. At 114, a node receives the validity results from multiple other peers and checks the consensus of the blockchain, if it receives more valid results than a pre-defined criteria. If there is a consensus, at 115, the node writes/finalizes the blockchain. A leader peer checks the overall progress of the validity check in other nodes and finishes at 116 the blockchain procedure.

For resilience, the total number of nodes is more than 3f+1 in some embodiments, wherein f is the number of allowed failure nodes. For example, f=1, there is a total 4 nodes; if f=3, there is a total of nodes, etc.

In some embodiments, the PBFT is with permission blockchains for mobility service blockchains, as discussed herein, providing at least partially the following features:

With respect to security, the PBFT provides in some embodiments a little risk of 51% attack, which is common for cryptocurrency because permission the peer which is in charge of consensus must be trusted. With respect to privacy, the end user cannot access the whole blockchain because only mobility service providers handle it at a (peer) node (due to the permission based blockchain and end users may not have the permission to access the blockchain). With respect to performance, the processing time for consensus is very short in some embodiments due to a small number of peers having a high performance. With respect to flexibility, the block size and format of blockchains can be flexible compared to public blockchains in some embodiments.

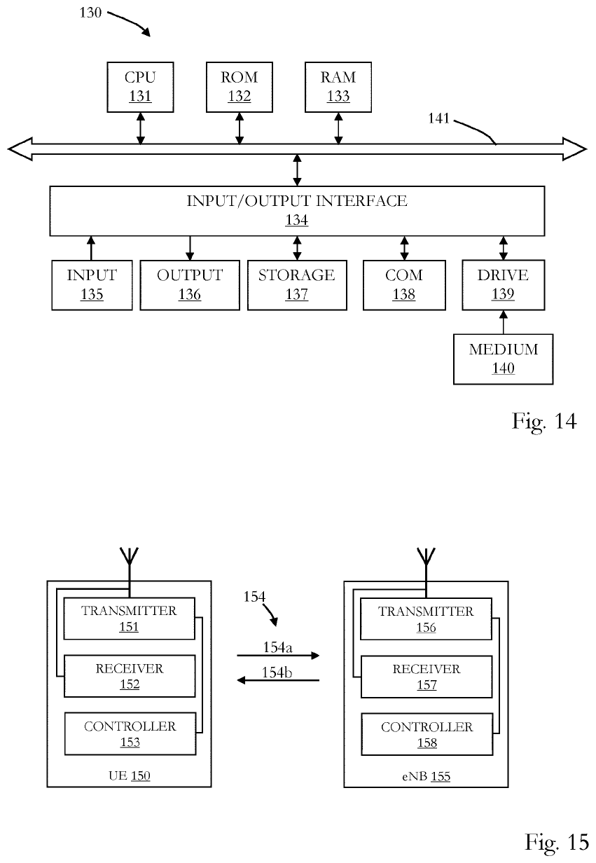

In the following, an embodiment of a general purpose computer 130 is described under reference of FIG. 14. The computer 130 can be implemented such that it can basically function as any type of network equipment, e.g. a network node, an identity hub, a part of a decentralized database, a base station or new radio base station, transmission and reception point, or communication device, such as user equipment, (end) terminal device or the like. The computer has components 131 to 141, which can form a circuitry, such as any one of the circuitries of the network equipments and communication devices, as described herein.

Embodiments which use software, firmware, programs or the like for performing the methods as described herein can be installed on computer 130, which is then configured to be suitable for the concrete embodiment.

The computer 130 has a CPU 131 (Central Processing Unit), which can execute various types of procedures and methods as described herein, for example, in accordance with programs stored in a read-only memory (ROM) 132, stored in a storage 137 and loaded into a random access memory (RAM) 133, stored on a medium 140 which can be inserted in a respective drive 139, etc.

The CPU 131, the ROM 132 and the RAM 133 are connected with a bus 141, which in turn is connected to an input/output interface 134. The number of CPUs, memories and storages is only exemplary, and the skilled person will appreciate that the computer 130 can be adapted and configured accordingly for meeting specific requirements which arise, when it functions as a base station or as user equipment (end terminal).

At the input/output interface 134, several components are connected: an input 135, an output 136, the storage 137, a communication interface 138 and the drive 139, into which a medium 140 (compact disc, digital video disc, compact flash memory, or the like) can be inserted.

The input 135 can be a pointer device (mouse, graphic table, or the like), a keyboard, a microphone, a camera, a touchscreen, etc.

The output 136 can have a display (liquid crystal display, cathode ray tube display, light emittance diode display, etc.), loudspeakers, etc.

The storage 137 can have a hard disk, a solid state drive and the like.

The communication interface 138 can be adapted to communicate, for example, via a local area network (LAN), wireless local area network (WLAN), mobile telecommunications system (GSM, UMTS, LTE, NR etc.), Bluetooth, infrared, etc.

It should be noted that the description above only pertains to an example configuration of computer 130. Alternative configurations may be implemented with additional or other sensors, storage devices, interfaces or the like. For example, the communication interface 138 may support other radio access technologies than the mentioned UMTS, LTE and NR.

When the computer 130 functions as a base station, the communication interface 138 can further have a respective air interface (providing e.g. E-UTRA protocols OFDMA (downlink) and SC-FDMA (uplink)) and network interfaces (implementing for example protocols such as S1-AP, GTP-U, S1-MME, X2-AP, or the like). Moreover, the computer 130 may have one or more antennas and/or an antenna array. The present disclosure is not limited to any particularities of such protocols.

An embodiment of a user equipment UE 150 and an eNB 155 (or NR eNB/gNB) and a communications path 154 between the UE 150 and the eNB 155, which are used for implementing embodiments of the present disclosure, is discussed under reference of FIG. 15. The UE 150 is an example of a communication device (or end-user entity) and the eNB is an example of a base station (e.g. a network node), without limiting the present disclosure in that regard.

The UE 150 has a transmitter 151, a receiver 152 and a controller 153, wherein, generally, the technical functionality of the transmitter 151, the receiver 152 and the controller 153 are known to the skilled person, and, thus, a more detailed description of them is omitted.

The eNB 155 has a transmitter 156, a receiver 157 and a controller 158, wherein also here, generally, the functionality of the transmitter 156, the receiver 157 and the controller 158 are known to the skilled person, and, thus, a more detailed description of them is omitted.

The communication path 154 has an uplink path 154a, which is from the UE 150 to the eNB 155, and a downlink path 154b, which is from the eNB 155 to the UE 150.

During operation, the controller 153 of the UE 150 controls the reception of downlink signals over the downlink path 154b at the receiver 152 and the controller 153 controls the transmission of uplink signals over the uplink path 154a via the transmitter 151.

Similarly, during operation, the controller 158 of the eNB 155 controls the transmission of downlink signals over the downlink path 154b over the transmitter 156 and the controller 158 controls the reception of uplink signals over the uplink path 154a at the receiver 157.

It should be recognized that the embodiments describe methods with an exemplary ordering of method steps. The specific ordering of method steps is however given for illustrative purposes only and should not be construed as binding. For example, the ordering of 41 and 42 in the embodiment of FIG. 5 may be exchanged. Also, the ordering of 51 and 52 in the embodiment of FIG. 6 may be exchanged. Further, also the ordering of 64 and 67 in the embodiment of FIG. 7 may be exchanged. Other changes of the ordering of method steps may be apparent to the skilled person.

Please note that the division of the computer 130 into units 131 to 140 is only made for illustration purposes and that the present disclosure is not limited to any specific division of functions in specific units. For instance, the computer 130 could be implemented by a respective programmed processor, field programmable gate array (FPGA) and the like.

In some embodiments, also a non-transitory computer-readable recording medium is provided that stores therein a computer program product, which, when executed by a processor, such as the processor described above, causes the method described to be performed.

All units and entities described in this specification and claimed in the appended claims can, if not stated otherwise, be implemented as integrated circuit logic, for example on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below.

(1) A communication network node comprising circuitry configured to:
acquire user input which is indicative of at least one service factor indicating user experience; and
predict a user experience based on a deterministic model including the at least one service factor.

(2) The communication network node of (1), wherein the at least one service factor includes a quantitative factor.

(3) The communication network node of (2), wherein the quantitative factor includes at least one of on-board time, waiting-time, waiting-time for transition, a number of changes, a number of persons at a station, a number of persons inside a train, transport costs, punctuality, unexpected delay, and a number of complaints to a transport service.

(4) The communication network node of anyone of (1) to (3), wherein the at least one service factor includes a qualitative factor.

(5) The communication network node of (4), wherein the qualitative factor includes at least one of comfort options, purpose of travel, additional travel services, accessibility, easiness of luggage handling, familiarity of the user with the transport service, familiarity of the user with the destination, risk of traffic accident, security, public safety, public health, and user health.

(6) The communication network node of anyone of (1) to (5), wherein the circuitry is further configured to:
acquire a measurement of the at least one service factor.

(7) The communication network node of (6), wherein the measurement is carried out by at least one of a railway control system, a smartphone, a and camera.

(8) The communication network node of anyone of (1) to (7), wherein the circuitry is further configured to:
carry out a deterministic calculation of the at least one service factor.

(9) The communication network node of (8), wherein the deterministic calculation includes calculating at least one of an on-board time, a waiting time, and a number of changes.

(10) The communication network node of (8) or (9), wherein the deterministic calculation is indicative of at least one of a preferable transport and a journey time.

(11) The communication network node of anyone of (8) to (10), wherein the deterministic calculation includes regression.

(12) The communication network node of (11), wherein the regression includes multiple pattern regression.

(13) The communication network node of anyone of (1) to (12), wherein the circuitry is further configured to:
acquire a travel history of the user.

(14) The communication network node of (13), wherein the circuitry is further configured to: prioritize a travel route based on the travel history.

(15) The communication network node of anyone of (1) to (14), wherein the deterministic model includes a machine learning algorithm.

(16) The communication network node of (15), wherein the machine learning algorithm is based on at least one input variable.

(17) The communication network node of (16), wherein the at least one input variable includes at least one of a measurement result, a calculation, historical data, and qualitative factors.

(18) The communication network node of anyone of (15) to (17), wherein the machine learning algorithm includes:
quantifying a qualitative factor of the at least one service factor based on the user input.

(19) The communication network node of anyone of (15) to (18), wherein the machine learning algorithm includes:
in the case of more than one input variable: reducing the at least one input variable based on a dimension reduction technique.

(20) The communication network node of anyone of (1) to (19), wherein the communication network node is for providing a distributed ledger.

(21) The communication network node of (20), wherein the distributed ledger is based on a blockchain.

(22) A method carried out in a communication network node, the method comprising:
acquiring user input which is indicative of at least one service factor indicating user experience; and
predicting a user experience based on a deterministic model including the at least one service factor.

(23) The method of (22), wherein the at least one service factor includes a quantitative factor.

(24) The method of (23), wherein the quantitative factor includes at least one of on-board time, waiting-time, waiting-time for transition, a number of changes, a number of persons at a station, a number of persons inside a train, transport costs, punctuality, unexpected delay, and a number of complaints to a transport service.

(25) The method of anyone of (22) to (24), wherein the at least one service factor includes a qualitative factor.

(26) The method of (25), wherein the qualitative factor includes at least one of comfort options, purpose of travel, additional travel services, accessibility, easiness of luggage handling, familiarity of the user with the transport service, familiarity of the user with the destination, risk of traffic accident, security, public safety, public health, and user health.

(27) The method of anyone of (22) to (26), wherein further comprising:
acquiring a measurement of the at least one service factor.

(28) The method of (27), wherein the measurement is carried out by at least one of a railway control system, a smartphone, a and camera.

(29) The method of anyone of (22) to (28), further comprising:
carrying out a deterministic calculation of the at least one service factor.

(30) The method of (29), wherein the deterministic calculation includes calculating at least one of an on-board time, a waiting time, and a number of changes.

(31) The method of (29) or (30), wherein the deterministic calculation is indicative of at least one of a preferable transport and a journey time.

(32) The method of anyone of (29) to (31), wherein the deterministic calculation includes regression.

(33) The method of (32), wherein the regression includes multiple pattern regression.

(34) The method of anyone of (22) to (33), further comprising:
acquiring a travel history of the user.

(35) The method of (34), further comprising:
prioritizing a travel route based on the travel history.

(36) The method of anyone of (22) to (35), wherein the deterministic model includes a machine learning algorithm.

(37) The method of (36), wherein the machine learning algorithm is based on at least one input variable.

(38) The method of (37), wherein the at least one input variable includes at least one of a measurement result, a calculation, historical data, and qualitative factors.

(39) The method of anyone of (36) to (38), wherein the machine learning algorithm includes:
quantifying a qualitative factor of the at least one service factor based on the user input.

(40) The method of anyone of (37) to (39), wherein the machine learning algorithm includes:
in the case of more than one input variable: reducing the at least one input variable based on a dimension reduction technique.

(41) The method of anyone of (22) to (40), wherein the communication network node is for providing a distributed ledger.

(42) The method of (41), wherein the distributed ledger is based on a blockchain.

(43) A computer program comprising program code causing a computer to perform the method according to anyone of (22) to (42), when being carried out on a computer.

(44) A non-transitory computer-readable recording medium that stores therein a computer program product, which, when executed by a processor, causes the method according to anyone of (22) to (42) to be performed.

(45) A communication network comprising a communication network node including circuitry configured to:
acquire user input which is indicative of at least one service factor indicating user experience; and
predict a user experience based on a deterministic model including the at least one service factor.

(46) A terminal device being configured to communicate with a communication network node in a communication network, the terminal device being further configured to:
provide a user input which is indicative of at least one service factor indicating user experience; and
obtain a user experience which is predicted based on a deterministic model including the at least one service factor.

1. A communication network node comprising circuitry configured to:
acquire user input which is indicative of at least one service factor indicating user experience; and
predict a user experience based on a deterministic model including the at least one service factor.

2. The communication network node of claim 1, wherein the at least one service factor includes a quantitative factor.

3. The communication network node of claim 2, wherein the quantitative factor includes at least one of on-board time, waiting-time, waiting-time for transition, a number of changes, a number of persons at a station, a number of persons inside a train, transport costs, punctuality, unexpected delay, and a number of complaints to a transport service.

4. The communication network node of claim 1, wherein the at least one service factor includes a qualitative factor.

5. The communication network node of claim 4, wherein the qualitative factor includes at least one of comfort options, purpose of travel, additional travel services, accessibility, easiness of luggage handling, familiarity of the user with the transport service, familiarity of the user with the destination, risk of traffic accident, security, public safety, public health, and user health.

6. The communication network node of claim 1, wherein the circuitry is further configured to:
acquire a measurement of the at least one service factor.

7. The communication network node of claim 6, wherein the measurement is carried out by at least one of a railway control system, a smartphone, and a camera.

8. The communication network node of claim 1, wherein the circuitry is further configured to:
carry out a deterministic calculation of the at least one service factor.

9. The communication network node of claim 8, wherein the deterministic calculation includes calculating at least one of an on-board time, a waiting time, and a number of changes.

10. The communication network node of claim 8, wherein the deterministic calculation is indicative of at least one of a preferable transport and a journey time.

11. The communication network node of claim 8, wherein the deterministic calculation includes regression.

12. The communication network node of claim 11, wherein the regression includes multiple pattern regression.

13. The communication network node of claim 1, wherein the circuitry is further configured to:
acquire a travel history of the user.

14. The communication network node of claim 13, wherein the circuitry is further configured to:
prioritize a travel route based on the travel history.

15. The communication network node of claim 1, wherein the deterministic model includes a machine learning algorithm.

16. The communication network node of claim 15, wherein the machine learning algorithm is based on at least one input variable.

17. (canceled)

18. The communication network node of claim 15, wherein the machine learning algorithm includes:
quantifying a qualitative factor of the at least one service factor based on the user input.

19. The communication network node of claim 15, wherein the machine learning algorithm includes:
in the case of more than one input variable: reducing the at least one input variable based on a dimension reduction technique.

20.-42. (canceled)

43. A communication network comprising a communication network node including circuitry configured to:
acquire user input which is indicative of at least one service factor indicating user experience; and
predict a user experience based on a deterministic model including the at least one service factor.

44. A terminal device being configured to communicate with a communication network node in a communication network, the terminal device being further configured to:
provide a user input which is indicative of at least one service factor indicating user experience; and
obtain a user experience which is predicted based on a deterministic model including the at least one service factor.
